(19) United States
(12) Patent Application Publication
(10) Pub. No.: US 2026/0098735 A1
(43) Pub. Date: Apr. 9, 2026

(54) ROUTE DISPLAY METHOD AND APPARATUS

(71) Applicant: HYUNDAI AUTOEVER CORP., Seoul (KR)

(72) Inventors: Nam Jun Kim, Seoul (KR); Sang Woo Kim, Seoul (KR)

(73) Assignee: HYUNDAI AUTOEVER CORP., Seoul (KR)

(21) Appl. No.: 19/349,841

(22) Filed: Oct. 3, 2025

(30) Foreign Application Priority Data
Oct. 4, 2024 (KR) 10-2024-0134735

(51) Int. Cl. G01C 21/34

(52) U.S. Cl. CPC G01C 21/3415; G01C 21/3492

(57) ABSTRACT

A route display method includes displaying a driving guidance screen corresponding to a first junction included in an existing route from a departure point to a destination. The route display method also includes detecting flashing of a turn signal in a direction deviating from a direction corresponding to the existing route at a location corresponding to the first junction. The route display method additionally includes, in response to detecting the flashing of the turn signal, displaying information regarding a change from the existing route.

### CROSS-REFERENCE TO RELATED APPLICATION

This application claims the benefit of and priority to Korean Patent Application No. 10-2024-0134735, filed on Oct. 4, 2024, the entire contents of which are hereby incorporated herein by reference.

### TECHNICAL FIELD

The present disclosure relates to a route display method and apparatus.

### BACKGROUND

The statements in this section merely provide background information related to the present disclosure and may not constitute prior art.

A navigation system helps a driver travel to a destination by finding an optimal route. The navigation system is interlinked with a Global Positioning System (GPS) to identify a current location and can provide route guidance based on real-time traffic information and map data. The navigation system may provide information such as estimated arrival time, traffic congestion, accidents, and construction zones. The navigation system may support the driver in following the route more easily through voice guidance and visual maps. The navigation system may be provided in various forms, such as smartphone applications or in-vehicle built-in systems.

The navigation system may present an alternative route to the currently guided route. Based on real-time traffic information, the navigation system may propose a detour reflecting situations such as congestion zones, accidents, or road construction. The navigation system may propose an alternative route for purposes such as route detour, time saving, or distance reduction, and may guide the driver to the alternative route by comparing the estimated travel time and distance between the selected route and the alternative route.

The navigation system may present an alternative route when the driver directly inputs information. However, direct input by the driver into the navigation system while driving may interfere with the driver's forward attention and become a cause of accidents.

### SUMMARY

Aspects of the present disclosure provide a technology that displays (e.g., automatically displays) information on an alternative route by recognizing the driver's intention during driving.

Aspects of the present disclosure provide a method for displaying information on an alternative route by recognizing a driver's intention to change a route.

Aspects of the present disclosure provide a method for presenting an alternative route to an existing route as promptly as possible based on an operational condition such as use of a turn signal provided in a vehicle.

The objectives of the present disclosure are not limited to those mentioned above. Other objectives not explicitly stated herein should be more clearly understood by those having ordinary skill in the art from the following description.

According to an aspect of the present disclosure, a route display method is provided. The route display method may be performed by a computing device. The route display method includes displaying a driving guidance screen corresponding to a first junction included in an existing route from a departure point to a destination. The route display method also includes detecting flashing of a turn signal in a direction deviating from a direction corresponding to the existing route at a location corresponding to the first junction. The route display method additionally includes, in response to detecting the flashing of the turn signal, displaying information regarding a change from the existing route.

In some embodiments, displaying the information regarding the change from the existing route may include displaying the information regarding the change from the existing route prior to execution of a route update procedure that is performed as a position of the computing device is changed due to a turn in a direction of the turn signal and subsequent driving.

In some embodiments, displaying the information regarding the change from the existing route may include calculating a distance between the first junction and a position of the computing device, and displaying the information regarding the change from the existing route on the driving guidance screen based on determining that the calculated distance is greater than or equal to a predetermined threshold.

In some embodiments, displaying the information regarding the change from the existing route may include calculating a time for the computing device to reach the first junction, and displaying the information regarding the change from the existing route on the driving guidance screen based on determining that the calculated time is greater than or equal to a predetermined threshold.

In some embodiments, displaying the information regarding the change from the existing route may include measuring a flashing duration of the turn signal, and displaying the information regarding the change from the existing route on the driving guidance screen based on determining that the measured flashing duration is greater than or equal to a predetermined threshold.

In some embodiments, displaying the information regarding the change from the existing route may include measuring a flash count of the turn signal, and displaying the information regarding the change from the existing route on the driving guidance screen based on determining that the measured flash count is greater than or equal to a predetermined threshold.

In some embodiments, displaying the information regarding the change from the existing route may include measuring a moving speed of the computing device, and displaying the information regarding the change from the existing route on the driving guidance screen based on detecting a change in the moving speed, of the computing device, resulting from the change from the existing route.

In some embodiments, the method may further comprise, in response to the flashing of the turn signal being detected, calculating a probability of the change from the existing route to an alternative route, and, based on determining that the calculated probability is greater than or equal to a predetermined threshold, displaying information regarding the alternative route.

According to the aforementioned and other embodiments of the present disclosure, a route display method is provided. The route display method may be performed by a computing device. The route display method includes displaying a driving guidance screen corresponding to a first junction included in an existing route from a departure point to a destination. The existing route includes a left turn or a right turn at the first junction. The route display method also includes detecting absence of flashing of a turn signal at a location corresponding to the first junction. The route display method additionally includes, in response to detecting the absence of the flashing of the turn signal, displaying information regarding a change from the existing route on the driving guidance screen.

In some embodiments, detecting the absence of the flashing of the turn signal may include detecting a turn signal absence situation when a flashing state of the turn signal is maintained only for a time less than or equal to a predetermined threshold.

In some embodiments, detecting the absence of the flashing of the turn signal may include detecting a turn signal absence situation when a flash count of the turn signal is less than or equal to a predetermined threshold.

In some embodiments, displaying the information regarding the change from the existing route may include measuring a moving speed of the computing device; determining a variation in the measured moving speed, and displaying the information regarding the change from the existing route based on determining that the variation does not fall within a predefined range of variations associated with a left turn or a right turn.

According to the aforementioned and other embodiments of the present disclosure, a route display method is provided. The route display method may be performed by a computing device. The route display method includes displaying a driving guidance screen corresponding to a first junction included in an existing route from a departure point to a destination. The route display method also includes detecting flashing of a turn signal for a lane change at a location corresponding to the first junction. The route display method additionally includes displaying information regarding a change from the existing route, resulting from the lane change.

It should be noted that the effects of the present disclosure are not limited to those described above. Other effects of the present disclosure that are not mentioned herein should be more apparent to those having ordinary skill in the art from the following description.

### BRIEF DESCRIPTION OF THE DRAWINGS

The above and other aspects and features of the present disclosure should become more apparent from the following detailed description taken in conjunction with the accompanying drawings, in which:

FIGS. 1 and 2 are conceptual diagrams illustrating the configuration of a route display system, according to an embodiment of the present disclosure;

FIG. 3 is a flowchart illustrating a route display method, according to an embodiment of the present disclosure;

FIG. 4 is a diagram illustrating a situation corresponding to the route display method of FIG. 3, according to an embodiment of the present disclosure;

FIG. 5 is a diagram illustrating a navigation display corresponding to the route display method of FIG. 3, according to an embodiment of the present disclosure;

FIG. 6 is a flowchart illustrating an embodiment of an operation of the route display method of FIG. 3, in which information on a route change effect is displayed;

FIG. 7 is a flowchart illustrating another embodiment of the operation of the route display method of FIG. 3, in which information on a route change effect is displayed;

FIG. 8 is a diagram illustrating a situation corresponding to explaining the embodiments of FIGS. 6 and 7, according to an embodiment of the present disclosure;

FIG. 9 is a flowchart illustrating another embodiment of the operation of the route display method of FIG. 3, in which information on a route change effect is displayed;

FIG. 10 is a flowchart illustrating another embodiment of the operation of the route display method of FIG. 3, in which information on a route change effect is displayed;

FIG. 11 is a flowchart illustrating another embodiment of the operation of the route display method of FIG. 3, in which information on a route change effect is displayed;

FIG. 12 is a flowchart illustrating a route display method, according to another embodiment of the present disclosure;

FIG. 13 is a flowchart illustrating a route display method, according to another embodiment of the present disclosure;

FIG. 14 is a diagram illustrating a situation corresponding to the route display method of FIG. 13, according to an embodiment of the present disclosure;

FIG. 15 is a flowchart illustrating an embodiment an operation of the route display method of FIG. 12, in which non-activation of a turn signal is detected;

FIG. 16 is a flowchart illustrating another embodiment of the operation of the route display method of FIG. 12, in which non-activation of a turn signal is detected;

FIG. 17 is a flowchart illustrating another embodiment of the operation of the route display method of FIG. 12, in which non-activation of a turn signal is detected;

FIG. 18 is a flowchart illustrating another embodiment of the operation of the route display method of FIG. 12, in which non-activation of a turn signal is detected;

FIG. 19 is a diagram illustrating a situation and a navigation display corresponding to the embodiment of FIG. 18, according to an embodiment of the present disclosure;

FIG. 20 is a diagram illustrating a driving guidance screen for a route display method, according to an embodiment of the present disclosure; and

FIG. 21 is a block diagram illustrating the hardware configuration of a computing device 1000 for a route display method, according to an embodiment of the present disclosure.

### DETAILED DESCRIPTION

Hereinafter, embodiments of the present disclosure are described in detail with reference to the accompanying drawings. The advantages and features of the present disclosure, and methods for achieving them, should become more apparent from the following detailed description taken in conjunction with the accompanying drawings. However, the technical spirit of the present disclosure is not limited to the described embodiments and may be implemented in various forms. The described embodiments are merely provided to fully disclose the technical spirit of the present disclosure and to fully convey the scope of the present disclosure to those having ordinary skill in the art. The technical spirit of the present disclosure is defined only by the scope of the claims.

In describing the present disclosure, specific descriptions of well-known components or functions have been omitted where it was determined that such descriptions may unnecessarily obscure the gist of the present disclosure.

Unless otherwise defined, terms (including technical and scientific terms) used in the following description may be used in a sense commonly understood by one of ordinary skill in the art to which the present disclosure pertains. However, the meanings of such terms may vary depending on the intention of a technician in the relevant field, legal precedent, the emergence of new technology, or other factors. The terms used in the present disclosure are for the purpose of describing embodiments and are not intended to limit the scope of the present disclosure.

In the following embodiments, singular expressions may include plural concepts unless clearly specified as singular from the context. Likewise, plural expressions may include singular concepts unless clearly specified as plural from the context.

Also, in the following description, terms such as first, second, A, B, (a), and (b) are used merely to distinguish one component from another, and such terms do not limit the nature, order, or sequence of the corresponding components.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Various embodiments of the present disclosure are hereinafter described with reference to the accompanying drawings.

In the present disclosure, a navigation device refers to a computing device that provides route guidance to the driver of a transportation means. In various embodiments, the computing device may include an in-vehicle terminal, a terminal installed in the vehicle, or a smartphone.

In the present disclosure, a driving route may refer to a route along which a vehicle is traveling from a departure point to a destination. In addition, the driving route may refer to a route that is currently being guided by the navigation device. The driving route may be changed from an existing route to an alternative route.

In the present disclosure, the existing route may refer to a route from the departure point to the destination of the vehicle before the vehicle reaches a first junction. The existing route may be guided by the navigation device. In addition, when the driving route is changed, the navigation device may no longer provide guidance on the existing route.

In the present disclosure, the alternative route may refer to a changed route from the departure point to the destination of the vehicle after the vehicle reaches the first junction. The alternative route may have the same departure point and destination as the existing route, but a different path from the existing route. When the driving route is changed, the alternative route may be guided by the navigation device.

In the present disclosure, a junction may refer to a geographic location at which the driving route can be changed from the existing route to the alternative route based on a driver's selection. The vehicle may change its driving direction or lane at the junction to change the driving route from the existing route to the alternative route. In addition, the junction may be a region within a preset distance from a location at which the driving route of the vehicle can be changed. For example, the junction may be a section within a preset distance from a turning section or an intersection where the vehicle can make a turn, or a section within a preset distance from an overpass entrance or an underpass entrance where the vehicle can enter an overpass or an underpass. It should be noted that the junction of the present disclosure is not limited to these examples.

In the present disclosure, route change effect information may refer to information related to changing the driving route from the existing route to the alternative route. For example, the route change effect information may include a change in an estimated arrival time resulting from the change of the driving route from the existing route to the alternative route, a change in a travel distance, or a display of an expected route on a map.

In the present disclosure, flashing of a turn signal may refer to a state in which the turn signal is turned on and repeatedly turned on and off automatically. When the turn signal is turned on once and then turned off once, it may be regarded as one flash of the turn signal. In addition, a turn signal flashing duration may refer to a time from when the turn signal is first turned on to when the turn signal is last turned off. Also, non-flashing of the turn signal may refer to a state in which the turn signal remains turned off continuously.

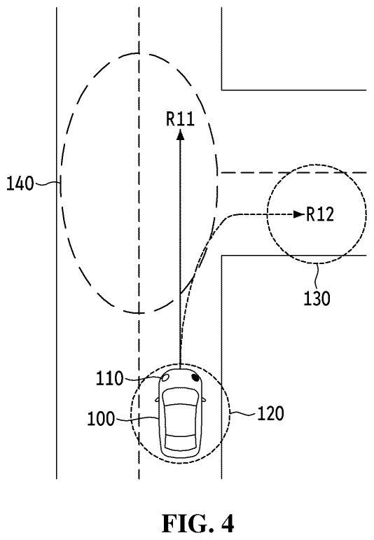

In the present disclosure, a driving guidance screen may refer to a display of the navigation device that shows a position on a map of a guided driving route and information on the driving route (e.g., a travel distance or an estimated arrival time). Specifically, for example, as illustrated in FIG. 5, the driving guidance screen may include a display of a map position 241a of the driving route and a display of information 242a on the driving route.

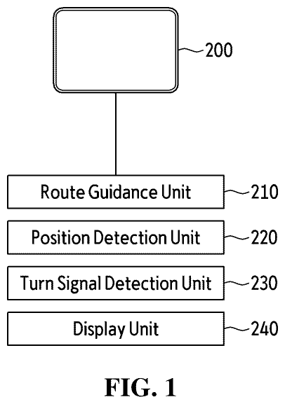

FIGS. 1 and 2 are conceptual diagrams illustrating a configuration of a route display system, according to an embodiment of the present disclosure.

Referring to FIG. 1, a route display system according to an embodiment of the present disclosure may a system provided in a navigation device 200. The navigation device 200 may include at least one of a route guidance unit 210, a position detection unit 220, a turn signal detection unit 230, or a display unit 240.

Referring to FIG. 2, a route display system according to an embodiment of the present disclosure is a system provided in the navigation device 200 and a server 300. The navigation device 200 and server 300 may communicate through a network 400. In this embodiment, the navigation device 200 may include at least one of the turn signal detection unit 230 or the display unit 240. In addition, the server 300 may include at least one of the route guidance unit 210 or the position detection unit 220. The network 400 may be implemented as any type of wired or wireless network, such as, for example, a local area network (LAN), a wide area network (WAN), a mobile radio communication network, or a wireless broadband Internet (WiBro).

Components of the route display system according to an embodiment of the present disclosure depicted in FIGS. 1 and 2 are described in more detail herein below.

The route guidance unit 210 may generate an existing route as a default route when a departure point and a destination are input by a driver, and may guide the driver along the existing route as a driving route. In addition, when flashing of a turn signal in a direction deviating from a direction of the existing route is detected, the route guidance unit 210 may generate an alternative route as a new route. The route guidance unit 210 may also generate information (hereinafter, the route change effect information) regarding the change of the driving route from the existing route to the alternative route. For example, if the existing route of a vehicle equipped with the navigation device 200 is a straight route and the driver flashes the turn signal, the alternative route of the vehicle becomes a turning route, and the route guidance unit 210 may generate the route change effect information (e.g., a display of the turning route on a map, an estimated arrival time when the turning route is selected, or a travel distance when the turning route is selected). Furthermore, when a position of the vehicle equipped with the navigation device 200 changes, the route guidance unit 210 may change the driving route from the existing route to the alternative route.

When non-flashing of a turn signal in a direction deviating from the direction of the existing route of the vehicle equipped with the navigation device 200 is detected, the route guidance unit 210 may generate the alternative route and generate the route change effect information. For example, when the existing route is a turning route and the turn signal is not flashed, the route guidance unit 210 may generate the alternative route (e.g., a straight route) and may generate the route change effect information (e.g., a display of the straight route on a map, an estimated arrival time when the straight route is selected, a travel distance when the straight route is selected).

It should be noted that, in an embodiment, these operations of the route guidance unit 210 are performed promptly after the turn signal of the vehicle equipped with the navigation device 200 is detected and before the vehicle moves along the alternative route.

The position detection unit 220 may detect a current position of the vehicle equipped with the navigation device 200. In addition, when flashing of a turn signal of the vehicle equipped with the navigation device 200 is detected, the position detection unit 220 may determine whether the vehicle is located within a preset distance from a junction.

The turn signal detection unit 230 may detect whether a turn signal of the vehicle equipped with the navigation device 200 is flashing. The turn signal detection unit 230 may also acquire information related to flashing of the turn signal of the vehicle (e.g., the direction, flashing duration, or number of flashes of the turn signal, or the speed of the vehicle during flashing of the turn signal).

The display unit 240 may display a driving guidance screen corresponding to a junction included in the existing route from the departure point to the destination of the vehicle equipped with the navigation device 200. In addition, the display unit 240 may display, on the driving guidance screen, information related to a change of the existing route in response to detection of flashing of a turn signal of the vehicle equipped with the navigation device 200. For example, when the existing route is a straight route and the driver flashes a turn signal within a preset distance from an intersection that serves as a junction, then in response to the detection of the flashing of the turn signal, information on the alternative route involving a right turn (e.g., an arrival time or a travel distance) may be displayed on the navigation device 200.

The configuration of the route display system according to an embodiment of the present disclosure has been described with reference to FIGS. 1 and 2. Hereinafter, a route display method according to some embodiments of the present disclosure is described, assuming that the route display system according to an embodiment of the present disclosure is configured with the navigation device 200 depicted in FIG. 1. However, this assumption is merely for convenience of explanation, and the subject of the route display method according to some embodiments of the present disclosure is not limited to the route display system illustrated in FIG. 1. It should be noted that the route display method according to some embodiments of the present disclosure may be executed by at least one computing device, for example the route display system illustrated in FIG. 2.

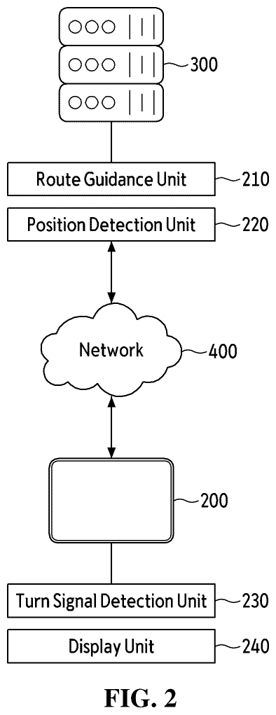

Embodiments related to a route display method using flashing of a turn signal are hereinafter be described in detail with reference to FIGS. 3-5.

For reference, the route display method according to some embodiments of the present disclosure represents steps and operations performed by the navigation device 200. Accordingly, in the following description, when the subject of a specific step or operation is omitted, the specific step or operation may be understood to be performed by the navigation device 200.

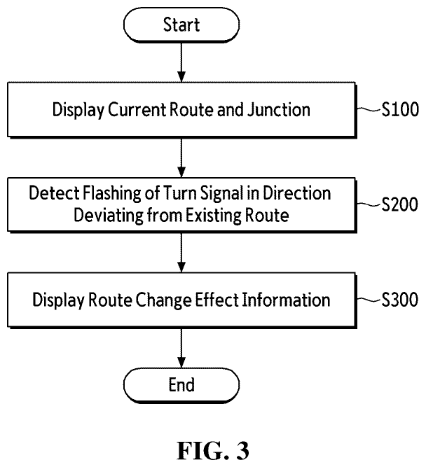

FIG. 3 is a flowchart illustrating a route display method according to an embodiment of the present disclosure. FIGS. 4 and 5 are diagrams illustrating situations corresponding to the route display method of FIG. 3 according to embodiments of the present disclosure.

Referring to FIG. 3, in an operation S100, the navigation device 200 may display a driving guidance screen corresponding to a junction included in a driving route from a departure point to a destination. In an embodiment, the driving route refers to an existing route. For example, as illustrated in FIG. 5, the display unit 240 of the navigation device 200 may display, as the driving guidance screen, a map 241a indicating a location of a vehicle on a map and an existing route to the destination, and driving information 242a according to the existing route, such as an estimated travel distance and arrival time.

In an operation S200, the navigation device 200 may detect flashing of a turn signal in a direction deviating from a direction of the existing route at a location corresponding to the junction.

For example, as illustrated in FIG. 4, the driver of a vehicle 100 equipped with the navigation device 200 may flash a right turn signal 110 at an intersection 140, which is the junction, in order to make a right turn. In an embodiment, the existing route of the vehicle 100 is a straight route R11, and the navigation device 200 is guiding the vehicle 100 along the existing route. The driver may flash the right turn signal 110 in order to obtain information on an alternative route, e.g., a right-turn route R12, before leaving the straight route R11. The navigation device 200 may determine that the current location of the vehicle 100 is within a preset distance from the junction 140. In addition, the turn signal detection unit 230 of the navigation device 200 may compare the direction of the straight route R11 with the direction indicated by the flashing right turn signal 110, i.e., a right-turn direction, and may detect it as flashing of a turn signal in a deviating direction.

In an operation S300, the navigation device 200 may display information (hereinafter, the route change effect information) regarding the change of the driving route of the vehicle from the existing route to the alternative route. In an embodiment, the route change effect information may be displayed on the navigation screen of the navigation device 200. In addition, the display of the route change effect information may include delivering the route change effect information to the driver via voice guidance. It should be noted that the display of the route change effect information may include any type of display recognizable by the driver of the vehicle equipped with the navigation device 200.

For example, as illustrated in FIG. 5, the display unit 240 of the navigation device 200 may display, as the driving guidance screen, a map 241b displaying both the existing route and the alternative route as the route change effect information, along with the driving information 242a according to the existing route and changes 243 in travel distance and arrival time.

In an embodiment, the operation S300, which is the operation of displaying the route change effect information, may include displaying the route change effect information before performing a route update procedure, as the vehicle equipped with the navigation device 200 changes it location due to a turn in the direction of the detected flashing turn signal and subsequent driving.

For example, as illustrated in FIG. 4, when the vehicle 100 equipped with the navigation device 200 reaches a post-right-turn point 130 along the right-turn route R12, which is a right-turn route, the navigation device 200 may update and display the driving route to the driver. According to an embodiment of the present disclosure, the route change effect information may be displayed before the update of the driving route, that is, at a pre-right-turn point 120.

Through this route display method, the driver of the vehicle 100 may promptly check information on the alternative route before changing the driving route from the existing route to the alternative route. In addition, the driver of the vehicle 100 may acquire information on the change of the driving route without having to directly input it into the navigation device 200. Since there is no need for the driver to directly input information, the driver can continue to focus on driving, thereby preventing accidents caused by diverted attention, or can appropriately respond to accidents, even if they occur.

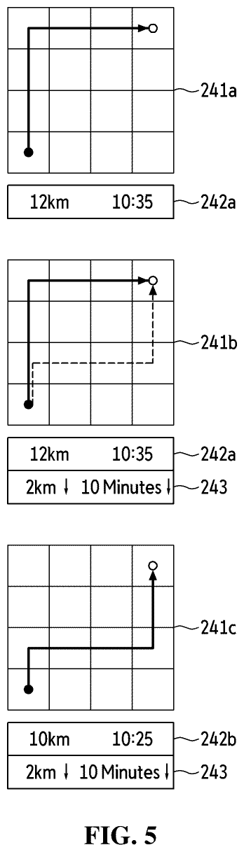

In some embodiments, there may be cases in which displaying the route change effect information by the navigation device 200 is impossible or unnecessary. For example, if the vehicle equipped with the navigation device 200 has already passed the junction before the route change effect information is displayed, the driver of the vehicle may no longer need the route change effect information. Therefore, to conserve computing resources of the navigation device 200, it is necessary to determine whether it is appropriate to display the route change effect information. Hereinafter, the operation of displaying the route change effect information, i.e., the operation S300, according to embodiments, is described in greater detail with reference to FIGS. 6-8.

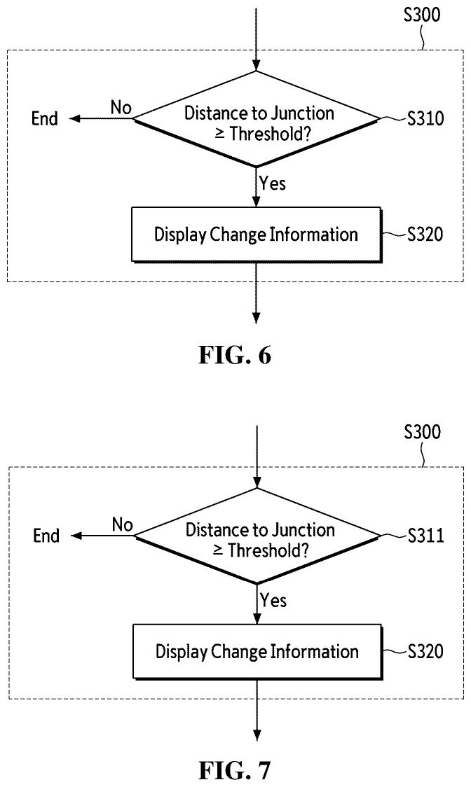

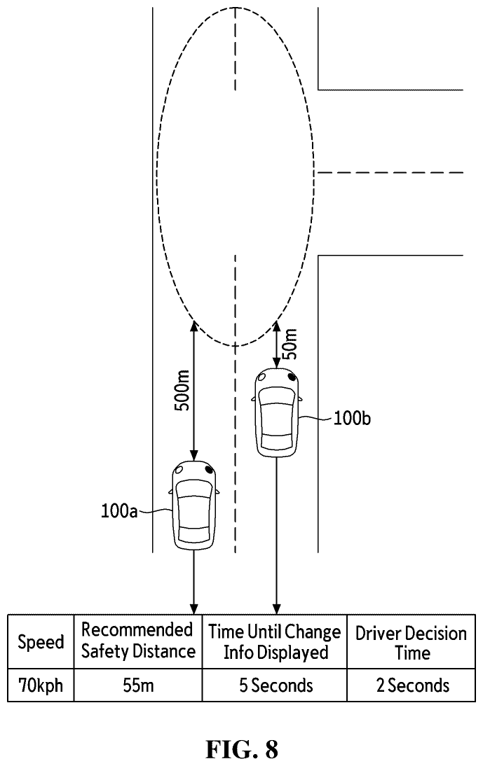

FIGS. 6 and 7 are flowcharts illustrating embodiments of the operation S300. FIG. 8 is a diagram illustrating a situation corresponding to the embodiment of FIG. 7.

Referring to FIG. 6, the operation S300 may include determining whether a distance from the current location of the vehicle equipped with the navigation device 200 to the junction is greater than or equal to a threshold in an operation S310, and, if the distance is greater than or equal to the threshold, displaying the route change effect information in an operation S320. In an embodiment, the threshold for the distance to the junction may be calculated or preset in consideration of the speed of the vehicle, the distance between the vehicle and the junction, a time required to display the route change effect information, and a time available for the driver of the vehicle to perceive and assess the route change effect information.

Referring to FIG. 7, the operation S300, which is the operation of displaying the route change effect information, may include determining whether a time for the vehicle equipped with the navigation device 200 to reach the junction is greater than or equal to a threshold in an operation S311, and, if the time to reach the junction is greater than or equal to the threshold, displaying the route change effect information in the operation S320. In an embodiment, the threshold for the time to reach the junction may be calculated or preset in consideration of the speed of the vehicle, the distance between the vehicle and the junction, a time required to display the route change effect information, and a time available for the driver of the vehicle to perceive and assess the route change effect information. For example, the threshold for the time to reach the junction may be a sum of the time required to display the route change effect information and the time required for the driver to perceive and assess the route change effect information.

For example, as illustrated in FIG. 8, assuming that the speed of vehicles 100a and 100b is 70 kilometers per hour (kph), the time required to display the route change effect information is 5 seconds, and the time for the drivers to perceive and assess the route change effect information is 2 seconds. Then, the threshold for the time to reach the junction may be 7 seconds, which is the sum of the time to display the route change effect information and the time to perceive and assess the route change effect information. In the case of the vehicle 100a, which is 500 meters from the junction, the time to reach the junction is approximately 25.7 seconds (≈500 m÷19.44 m/s). Since the time to reach the junction of vehicle 100a is greater than the threshold of 7 seconds, the navigation device 200 of the vehicle 100a may display the route change effect information. On the other hand, in the case of the vehicle 100b, which is 50 meters from the junction, the time to reach the junction is approximately 2.6 seconds (≈50 m÷16.67 m/s). Since the time to reach the junction of the vehicle 100b is less than the threshold of 7 seconds, the navigation device 200 of the vehicle 100b does not display the route change effect information.

Through this route display method, when the distance to the junction or the time to reach the junction is greater than or equal to the threshold, the route change effect information is displayed before the vehicle equipped with the navigation device 200 reaches the junction, allowing the driver to view the route change effect information and select a route. On the other hand, when the distance to the junction or the time to reach the junction is less than the threshold, the route change effect information is displayed after the vehicle has reached the junction, making it impossible for the driver to select a route based on the route change effect information. Therefore, by displaying the route change effect information only when the distance to the junction is greater than or equal to the threshold, practical support for the driver's route selection can be provided.

The threshold for the distance to the junction or the time to reach the junction is not limited to the above examples and may be calculated or set based on any criteria that enable the driver of the vehicle equipped with the navigation device 200 to view the route change effect information and select a route at the junction before reaching it.

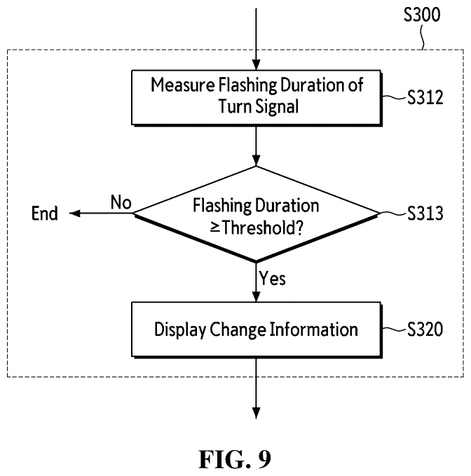

In some cases, flashing of a turn signal by a driver may not necessarily indicate an intention to change a route. For example, the driver may accidentally operate the turn signal or visually assess the situation on an alternative route and decide not to change the route. Therefore, to conserve the computing resources of the navigation device 200, it is necessary to determine whether the driver has an intention to change the route. Hereinafter, the operation S300, which is the operation of displaying the route change effect information, according to embodiments, is described in further detail with reference to FIGS. 9-11.

Referring to FIG. 9, the operation S300, which is the operation of displaying route change effect information, may include measuring the flashing duration of a turn signal of the vehicle equipped with the navigation device 200 in an operation S312, determining whether the measured flashing duration is greater than or equal to a threshold in an operation S313, and, if the measured flashing duration is greater than or equal to the threshold, displaying the route change effect information in the operation S320. In an embodiment, the threshold for the flashing duration may be, for example, a recommended minimum operational time of a turn signal as prescribed by a traffic regulatory agency. The minimum operational time of a turn signal may refer to a duration during which a driver is regarded as intending to change the direction of the vehicle.

For example, while driving on a general road near a location determined to be a junction, the driver of the vehicle equipped with the navigation device 200 may inadvertently flash a turn signal for 2 seconds. If the traffic regulatory agency recommends a minimum operational time of 3 seconds for a turn signal on a general road, the threshold for the flashing duration may be set to 3 seconds. Therefore, since the flashing duration of 2 seconds is less than the threshold, the navigation device 200 may not display the route change effect information.

Conversely, the driver of the vehicle may intentionally operate a turn signal for 3 seconds near a location determined to be a junction while driving on a general road. Since the flashing duration of 3 seconds is equal to the threshold of 3 seconds, the navigation device 200 may display the route change effect information.

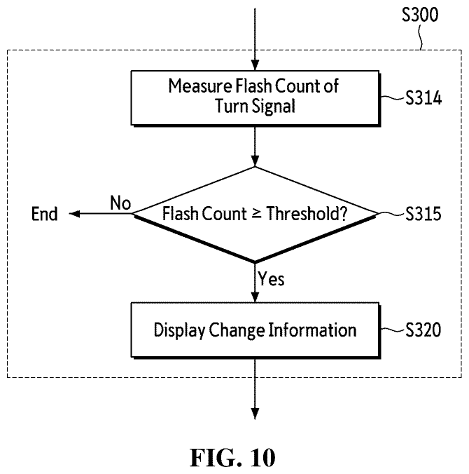

Referring to FIG. 10, the operation S300 may include measuring the flash count of a turn signal of the vehicle equipped with the navigation device 200 in an operation S314, determining whether the measured flash count is greater than or equal to a threshold in an operation S315, and, if the measured flash count is greater than or equal to the threshold, displaying the route change effect information in the operation S320. In an embodiment, the threshold for the flash count may be, for example, a recommended minimum number of flashes of a turn signal as prescribed by a traffic regulatory agency. The minimum number of flashes may refer to how many times a driver expresses an intention to change the direction of a vehicle.

For example, while driving on a general road near a location determined to be a junction, the driver of the vehicle equipped with the navigation device 200 may flash a turn signal twice to change the driving route but then cancel the flashing after observing an accident on an alternative route. If the traffic regulatory agency recommends a minimum of four flashes for a general road, the threshold for the flash count may be set to 4. Since the flash count of 2 is less than the threshold of 4, the navigation device 200 may not display the route change effect information.

Conversely, if the driver of the vehicle equipped with the navigation device 200 intentionally flashes a turn signal five times with the intention of altering the driving route near a location determined to be a junction while driving on a general road, the navigation device 200 may display the route change effect information because the flash count of 5 is greater than the threshold of 4.

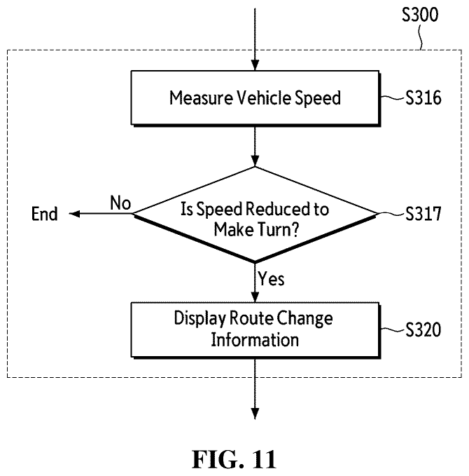

Referring to FIG. 11, the operation S300 may also include measuring the speed of the vehicle equipped with the navigation device 200 in an operation S316, determining whether the vehicle reduces its speed in order to make a turn in an operation S317, and, if the vehicle reduces its speed for a turn, displaying the route change effect information in the operation S320.

For example, as illustrated in FIG. 4, the existing route of the vehicle 100 may be the straight route R11, and the alternative route may be the right-turn route R12. If the driver of the vehicle 100 flashes the right turn signal 110, the navigation device 200 may measure the speed of the vehicle 100. If the speed of the vehicle 100 does not decrease or increases instead, it may be interpreted that the driver does not intend to make a right turn, and therefore, the navigation device 200 may not display the route change effect information. Conversely, if the speed of the vehicle 100 decreases, it may be determined that the driver intends to make a right turn, and the navigation device 200 may display the route change effect information.

Through this route display method, the navigation device 200 may accurately reflect the driver's driving intention. In addition, when the driver does not intend to change the driving route from the existing route to the alternative route, the navigation device 200 may avoid displaying the route change effect information, thereby conserving its computing resources.

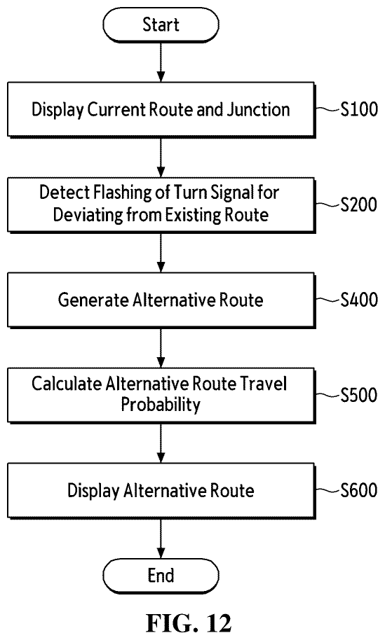

Thus far, with reference to FIGS. 3-11, a route display method has been described in which flashing of a turn signal at a junction is detected, and route change effect information is displayed accordingly. In some cases, if the driving route of the vehicle 100 is highly likely to change from an existing route to an alternative route, the navigation device 200 may change the guided route from the existing route to the alternative route. Hereinafter, an embodiment of how to change the guided route to the alternative route is described in detail with reference to FIG. 12, focusing only on the different steps or operations from the embodiment of FIG. 2.

Referring to FIG. 12, in operation S400, when flashing of a turn signal in a direction deviating from the direction of the existing route is detected at a location corresponding to a junction, the navigation device 200 may generate an alternative route. In an embodiment, generating the alternative route does not necessarily mean immediately displaying the alternative route on the display of the navigation device 200.

For example, as illustrated in FIG. 4, if the driver of the vehicle 100 equipped with the navigation device 200 flashes the right turn signal 110 to indicate an intention to make a right turn, the navigation device 200 may generate the right-turn route R12.

In an operation S500, the navigation device 200 may calculate the probability of changing the driving route from the existing route to the alternative route. The probability of changing the driving route may be calculated by considering route change-related data of the navigation device 200 (e.g., data on how often vehicles change routes at the junction, changes in travel distance and arrival time when the driving route is changed, traffic conditions, congestion level, presence of construction or accidents on the road, and historical data on the driver's route changes).

For example, as illustrated in FIG. 4, the navigation device 200 may calculate a probability (hereinafter, the change probability) that the vehicle 100 will change its driving route to the right-turn route R12. The navigation device 200 may calculate the change probability based on statistics indicating whether vehicles with the same destination as the vehicle 100 followed the straight route R11 or the right-turn route R12. In addition, the navigation device 200 may calculate the change probability based on statistics on whether the vehicle 100 has followed the straight route R11 or the right-turn route R12 in previous trips toward the same destination at the same junction. Furthermore, the navigation device 200 may calculate the change probability based on data such as differences in arrival time, travel distance, or traffic congestion level between the straight route R11 and the right-turn route R12.

In an operation S600, if the calculated probability that the vehicle's driving route will change from the existing route to the alternative route is greater than or equal to a preset threshold, the navigation device 200 may display information corresponding to the alternative route before the vehicle moves along the alternative route so that the driving route is updated.

For example, as illustrated in FIG. 5, the display unit 240 of the navigation device 200 may display a map 241c showing only the alternative route from the current location of the vehicle to the destination. In addition, the display unit 240 may display an estimated travel distance and arrival time 242b of the alternative route, and may also display changes 243 in travel distance and arrival time in parallel.

Through this route display method, as the guided route is changed to the alternative route, information on the route change (e.g., travel distance, arrival time, and instructions during driving) can be quickly provided to the driver. In addition, by updating the guided route to an anticipated route before the actual route change, any gap in navigation guidance can be minimized.

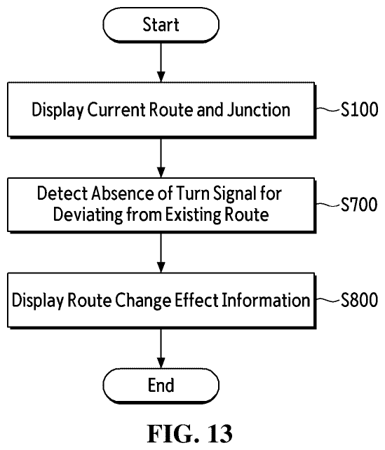

Thus far, with reference to FIGS. 3-12, a route display method has been described in which, when the driver of the vehicle equipped with the navigation device 200 flashes a turn signal at a junction, an alternative route is displayed after determining the driver's intention. Hereinafter, with reference to FIGS. 13-17, a route display method is described in which, even when the driver does not flash a turn signal at the junction, the alternative route is displayed after determining the driver's intention, according to embodiments.

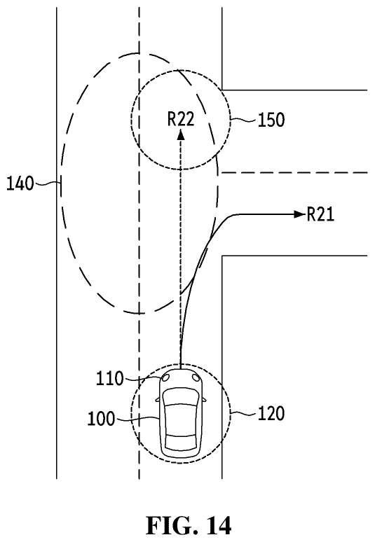

FIG. 13 is a flowchart illustrating a route display method according to another embodiment of the present disclosure. FIG. 14 is a diagram illustrating a situation corresponding to the route display method of FIG. 13 according to an embodiment of the present disclosure.

Referring to FIG. 13, in the operation S100, the navigation device 200 may display a driving guidance screen corresponding to a junction included in an existing route from a departure point to a destination. In an embodiment, the existing route refers to a route involving a left or right turn at the junction.

In an operation S700, the navigation device 200 may detect an absence of turn signal flashing at a location corresponding to the junction.

For example, as illustrated in FIG. 14, if the existing route of the vehicle 100 equipped with the navigation device 200 is a right-turn route R21 and the driver of the vehicle 100 does not flash the turn signal 110, the navigation device 200 may detect an absence of turn signal flashing in the direction deviating from the right-turn route R21, i.e., in the straight-ahead direction. Based on the right-turn route R21 and the absence of turn signal flashing by the driver, the navigation device 200 may interpret the driver as intending to go straight.

In an operation S800, in response to detecting the absence of turn signal flashing, the navigation device 200 may display information (hereinafter, the route change effect information) regarding the change of the driving route the existing route to an alternative route on the driving guidance screen.

For example, as illustrated in FIG. 5, the display unit 240 of the navigation device 200 may display, in parallel, the driving information 242a according to the existing route, the map 241b showing both the existing route and the alternative route as the route change effect information, and the changes 243 in travel distance and arrival time.

In an embodiment, the operation S900, which is the operation of displaying the route change effect information, may include displaying the route change effect information before performing a route update procedure as the location of the vehicle equipped with the navigation device 200 is changed in response to the rotation and subsequent driving of the vehicle equipped with the navigation device 200 in the direction corresponding to the turn signal in which the absence of flashing has been detected.

For example, as illustrated in FIG. 14, after detecting that the driver of the vehicle 100 has not flashed a turn signal within a preset distance from the junction, the navigation device 200 may display the route change effect information before the vehicle 100 moves along an alternative route, e.g., a straight route R22, to a location 150 so that the driving route is updated by the navigation device 200.

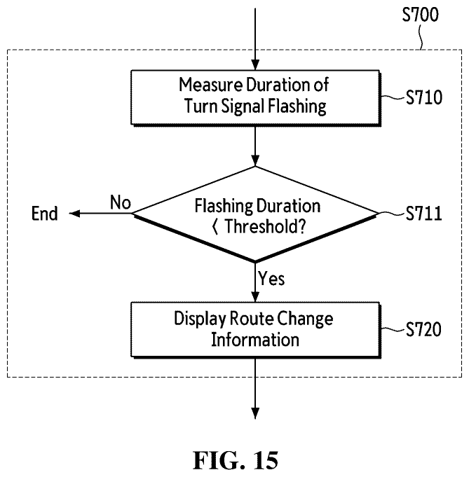

Momentary flashing of a turn signal by the driver may be intended as an absence of turn signal flashing. For example, after flashing a turn signal to turn according to the existing route, the driver may immediately decide to switch to the alternative route without flashing the turn signal again. In this case, to conserve computing resources of the navigation device 200, it is necessary to determine whether the driver intends to change the driving route. Hereinafter, the operation S800, which is the operation of displaying route change effect information, according to embodiments, is described in more detail with reference to FIGS. 15-17.

Referring to FIG. 15, the operation S700, which is the operation of detecting the absence of turn signal flashing, may include measuring the flashing duration of a turn signal of the vehicle equipped with the navigation device 200 in an operation S710, and determining whether the measured flashing duration is less than a threshold in an operation S711. If the measured flashing duration is less than the threshold, the route change effect information may be displayed in an operation S720 (corresponding to the operation S800). In an embodiment, the threshold for the flashing duration may be, for example, a recommended minimum operational time of a turn signal as prescribed by a traffic regulatory agency.

In other words, the operation S700, which is the operation of detecting the absence of turn signal flashing, may include detecting an absence of turn signal flashing when the flashing state of the turn signal is maintained for only a period less than or equal to a predefined threshold.

For example, as illustrated in FIG. 14, if the driver of the vehicle 100 flashes the turn signal 110 for 2 seconds to turn right according to the existing route, i.e., the right-turn route R21 and then turns off the turn signal 110 to go straight according to the alternative route, i.e., the straight route R22, the driver may be regarded as intending to go straight. If the recommended minimum operational time of a turn signal by the traffic regulatory agency is 3 seconds, the threshold for a flashing duration may be set to 3 seconds. Therefore, since the flashing duration of 2 seconds is less than the threshold of 3 seconds, the navigation device 200 may treat it as an absence of turn signal flashing and may then display the route change effect information to the driver.

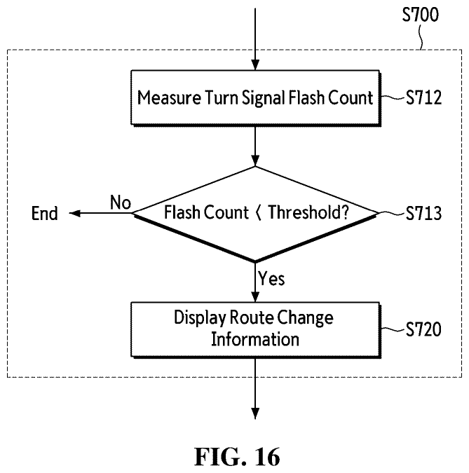

Referring to FIG. 16, the operation S700, which is the operation of detecting the absence of turn signal flashing, may include measuring the flash count of a turn signal of the vehicle equipped with the navigation device 200 in an operation S712, and determining whether the measured flash count is less than a threshold in an S713. If the measured flash count is less than the threshold, the route change effect information may be displayed in an operation S720 (corresponding to the operation S800). In an embodiment, the threshold for the flash count may be, for example, a recommended minimum flash count of a turn signal as prescribed by a traffic regulatory agency.

In other words, the operation S700, which is the operation of detecting the absence of turn signal flashing, may include detecting an absence of turn signal flashing when the flash count of the turn signal is equal to or less than a preset threshold.

For example, as illustrated in FIG. 14, if the driver of the vehicle 100 flashes the turn signal 110 twice to turn right according to the right-turn route R21 and then turns off the turn signal to go straight according to the straight route R22, the driver may be regarded as intending to go straight. If the recommended minimum flash count of a turn signal on a general road by the traffic regulatory agency is 4 to 5, the threshold may be set to four. Since the flash count of 2 is less than the threshold of 4, the navigation device 200 may treat it as an absence of turn signal flashing and may then display the route change effect information.

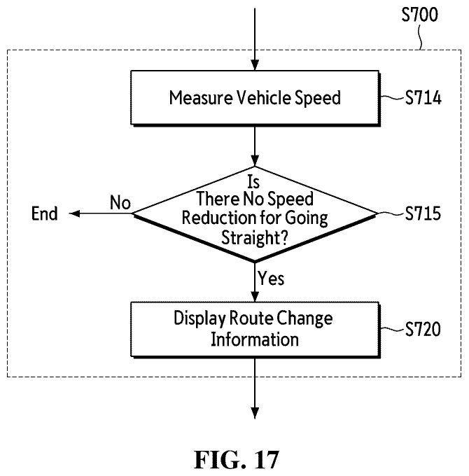

Referring to FIG. 17, the operation S800, which is the operation of displaying the route change effect information, may include measuring the speed of the vehicle equipped with the navigation device 200 in an operation S714, determining a change amount of the measured speed and determining whether the determined change amount falls within a predefined change range corresponding to a left turn or a right turn in an operation S715, and, if the determined change amount does not fall within the predefined change range for a left turn or a right turn, displaying the route change effect information in the operation S720.

For example, as illustrated in FIG. 14, the existing route of the vehicle 100 may be the right-turn route R21, and the alternative route may be the straight route R22. If the driver of the vehicle 100 does not flash the turn signal 110, the navigation device 200 may measure the speed of the vehicle 100. If the measurement result shows that the vehicle 100 does not decelerate for the right turn, it may be determined that the driver does not intend to turn right according to the existing route, and the navigation device 200 may display the route change effect information. Conversely, if the speed of the vehicle 100 decreases, it may be determined that the driver intends to turn right according to the existing route, and the navigation device 200 may not display the route change effect information.

Through this route display method, the navigation device 200 may treat flashing of the turn signal for less than a certain duration or by less than a certain count as an absence of turn signal flashing. In addition, the navigation device 200 may accurately reflect the driver's driving intention. Furthermore, when the driver does not intend to change the driving route from the existing route to the alternative route, the navigation device 200 may avoid displaying the route change effect information, thereby conserving its computing resources.

In one embodiment, even when the turn signal is not flashed at the junction, similar to a case where the turn signal is flashed, the navigation device 200 may change the guided route from the existing route to the alternative route if it is certain that the driving route of the vehicle equipped with the navigation device 200 will change from the existing route to the alternative route.

First, if the navigation device 200 detects an absence of turn signal flashing at a location corresponding to a junction, the navigation device 200 may generate an alternative route.

For example, as illustrated in FIG. 14, if the driver of the vehicle 100 does not flash the turn signal 110 and thus intends to go straight, the navigation device 200 may generate the straight route R22 that goes straight to reach the destination as an alternative route.

Thereafter, the navigation device 200 may calculate a probability that the vehicle equipped with the navigation device 200 will travel along the alternative route. If the probability that the vehicle will travel along the alternative route is greater than or equal to a threshold, the navigation device 200 may display a driving guidance screen corresponding to the alternative route before the vehicle starts to travel along the alternative route.

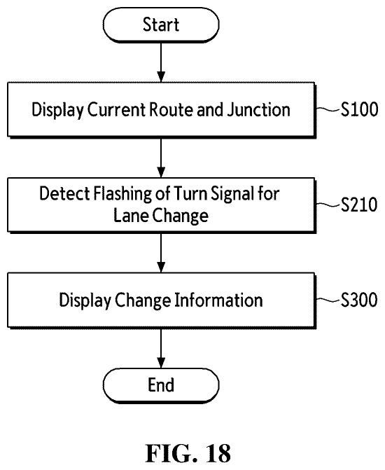

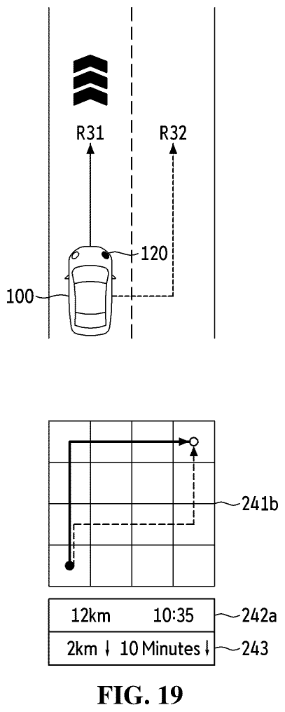

Thus far, with reference to FIGS. 13-17, a route display method has been described in which route change effect information is displayed based on detection of an absence of turn signal flashing at a junction. In some cases, there may be cases where the driving route changes without a turn at the junction. Hereinafter, with reference to FIGS. 18-19, a route display method is described for a case in which the route of the vehicle 100 is expected to change without making a turn at the junction, according to an embodiment of the present disclosure.

FIG. 18 is a flowchart illustrating a route display method according to another embodiment of the present disclosure. FIG. 19 is a diagram illustrating a situation corresponding to the route display method of FIG. 18 according to an embodiment of the present disclosure.

Referring to FIG. 18, the navigation device 200 may display a driving guidance screen corresponding to a junction included in an existing route from a departure point to a destination in the operation S100. In an operation S210, the navigation device 200 may detect flashing of a turn signal for a lane change at a location corresponding to the junction. Then, the navigation device 200 may display information regarding the change of the driving route from the existing route to an alternative route due to the lane change in the operation S300.

For example, as illustrated in FIG. 19, the driver of the vehicle 100 may be traveling along the existing route, i.e., a route R31 to enter an overpass. At a junction where the driver may choose whether to enter the overpass, the driver of the vehicle 100 may flash a turn signal 120 to change lanes. The navigation device 200 may detect flashing of the turn signal 120 for a lane change.

Thereafter, as illustrated in FIG. 19, the navigation device 200 may generate an alternative route that may result from a lane change corresponding to the flashing of the turn signal 120. If the vehicle 100 changes lanes, the vehicle 100 will be unable to enter the overpass, and thus, a route R32 that does not enter the overpass may be generated as the alternative route.

Thereafter, as illustrated in FIG. 19, the navigation device 200 may display, together with travel distance and arrival time information 242a according to the existing route, the map route 241b and the changes 243 in travel distance and arrival time resulting from the change from the existing route to the alternative route, i.e., from the route R31 to the route R32.

A case where the driving route of the vehicle 100 is expected to change without making a turn at a junction according to an embodiment of the present disclosure may include entering an underground road or a tunnel, but the present disclosure is not limited thereto.

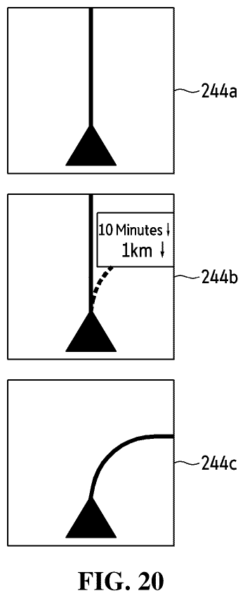

FIG. 20 is a diagram illustrating a driving guidance screen according to an embodiment of the present disclosure.

As illustrated in FIG. 20, before the vehicle equipped with the navigation device 200 reaches a junction, the navigation device 200 may display only information on the existing route, which is the driving route. For example, existing route information 244a may include the current position of the vehicle 100 and the map location of the existing route.

Thereafter, the navigation device 200 may display route change effect information after detecting flashing or absence of flashing of a turn signal in a direction deviating from the existing route at the junction. Specifically, for example, as illustrated in FIG. 20, the navigation device 200 may display a change in arrival time (e.g., 10 minutes ↓) and a change in travel distance (e.g., 1 km ↓) resulting from the change of the driving route as the route change effect information 244b. The navigation device 200 may also display the map location of an alternative route as the route change effect information 244b. In an embodiment, the map location of the alternative route may be displayed to be distinguishable from the map location of the existing route. However, the method for displaying the route change effect information 244b is not limited thereto.

Thereafter, when the turn signal in the direction deviating from the existing route is turned off after being flashed at the junction, the navigation device 200 may re-display the existing route information 244a. Also, if the turn signal in the direction deviating from the existing route is turned on after initially not being flashed, the navigation device 200 may again display the existing route information 244a. For example, if the driver of the vehicle equipped with the navigation device 200 flashes a turn signal with the intention to change the driving route and then intentionally turns it off, the navigation device 200 may immediately display only the existing route information 244a.

Thereafter, if the vehicle equipped with the navigation device 200 moves along the alternative route while the flashing or absence of flashing of the turn signal in the direction deviating from the existing route is being continued, the navigation device 200 may immediately display only alternative route information 244c. For example, while the navigation device 200 is displaying the route change effect information (e.g., changes in arrival time and travel distance in the case of a right turn), if the driver makes a right turn and the vehicle's location changes accordingly, the navigation device 200 may change the driving route to a right-turn route and display only right-turn route information as the alternative route information 244c.

Through this route display method, the driving route may be changed readily in response to the driver's operation of a turn signal. Furthermore, as location information (e.g., GPS information) of the vehicle changes, the navigation device 200 may guide the driving route without calculating a new route by quickly switching to a preexisting alternative route.

According to the route display methods of the present disclosure, the driver of the vehicle equipped with the navigation device 200 may identify information on an alternative route before changing the driving route from the existing route to the alternative route and may acquire information on the change of the driving route, without having to directly input it into the navigation device 200. Since the driver does not directly input information, the driver may continue focusing on driving, thereby preventing accidents that may occur due to not watching the road, or responding more easily even if an accident occurs.

In addition, according to the route display methods of the present disclosure, route change effect information may be displayed before the vehicle reaches a junction, only when the distance or arrival time to the junction is greater than or equal to a threshold. Thus, the driver may be able to make a route selection based on the route change effect information. Conversely, if the distance or arrival time to the junction is less than the threshold, the route change effect information may be displayed after the vehicle reaches the junction, in which case, the driver may not be able to make a route selection based on the route change effect information. Therefore, the driver's route selection may be supported by displaying the route change effect information only when the distance to the junction is greater than or equal to the threshold.

Furthermore, the route display methods of the present disclosure may accurately reflect the driver's driving intention. Also, when the driver does not intend to change the driving route from the existing route to the alternative route, computing resources of the navigation device 200 may be conserved by not displaying the route change effect information.

Additionally, the route display methods of the present disclosure may quickly provide information on the change of the driving route (e.g., travel distance, arrival time, or driving instructions) to the driver and may minimize any interruption in route guidance by switching to an expected route before the driver actually changes the driving route.

Also, the route display methods of the present disclosure may immediately change the driving route in response to the driver's operation of a turn signal, and may provide guidance along the changed driving route without calculating a new route by using a preexisting alternative route as location information (e.g., GPS information) of the vehicle equipped with the navigation device 200 is changed.

The technical effects according to the concept of the present disclosure are not limited to those mentioned above. Other effects not described herein should be more clearly understood by one of ordinary skill in the art from the contents of the present disclosure.

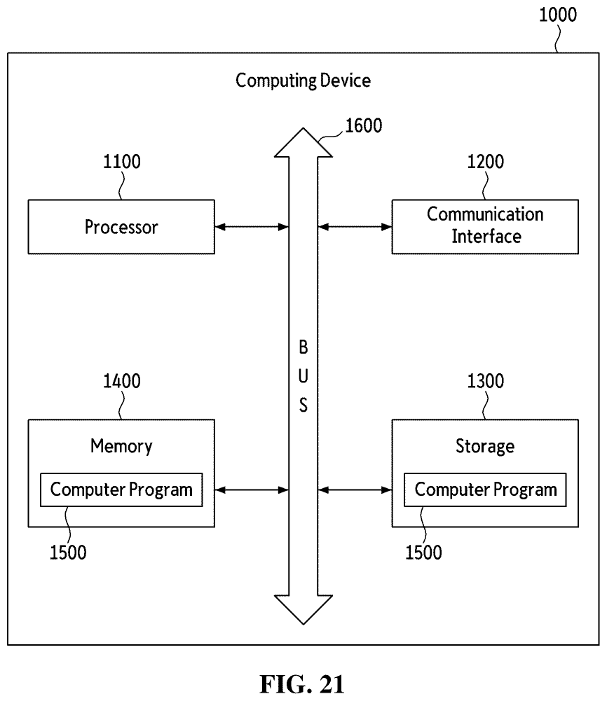

Hereinafter, a configuration of an example computing device according to some embodiments of the present disclosure is described with reference to FIG. 21. The computing device may correspond to the navigation device 200 or the server 300.

FIG. 21 is a block diagram illustrating the hardware configuration of a computing device 1000 according to some embodiments of the present disclosure. Referring to FIG. 21, a computing device 1000 may include at least one processor 1100, a system bus 1600, a communication interface 1200, a memory 1400 that loads a computer program 1500 executable by the processor 1100, and a storage 1300 that stores the computer program 1500. However, only components relevant to the embodiments of the present disclosure are illustrated in FIG. 21. Therefore, one of ordinary skill in the art to which the present disclosure pertains should understand that, in addition to the components depicted in FIG. 21, other general-purpose components may be further included.

The processor 1100 controls overall operations of the components of the computing device 1000. The processor 1100 may include at least one of a central processing unit (CPU), a micro processing unit (MPU), a micro controller unit (MCU), a graphics processing unit (GPU), or any other type of processor well known in the technical field of the present disclosure. The processor 1100 may perform computations for executing at least one application or program to implement methods or operations according to various embodiments of the present disclosure. The computing device 1000 may include two or more processors 1100.

The memory 1400 stores various types of content, commands, and/or information. The memory 1400 may load one or more computer programs 1500 from the storage 1300 to execute the methods or operations according to various embodiments of the present disclosure. The memory 1400 may be random-access memory (RAM), but the present disclosure is not limited thereto. The system bus 1600 provides communication functions between the components of the computing device 1000.

The system bus 1600 may be implemented as various types of buses, including an address bus, a content bus, and a control bus. The communication interface 1200 supports wired or wireless Internet communication of the computing device 1000. In addition to Internet communication, the communication interface 1200 may support various other types of communication. To this end, the communication interface 1200 may include a communication module well known in the technical field of the present disclosure. The storage 1300 may non-transitorily store one or more computer programs 1500. The storage 1300 may include a nonvolatile memory such as flash memory, a hard disk, a removable disk, or any other computer-readable recording medium known in the technical field of the present disclosure.

The computer program 1500 may include one or more computer-readable instructions for implementing the methods or operations according to various embodiments of the present disclosure. When loaded into the memory 1400, the processor 1100 may execute the one or more instructions to perform the methods or operations according to various embodiments of the present disclosure.

Although operations are illustrated in a specific order in the drawings, it should not be understood that the operations must be executed in the specific or sequential order shown, or that all the illustrated operations must be executed to obtain the desired result. In certain situations, multitasking and parallel processing may be advantageous. Furthermore, the separation of various configurations in the embodiments described above should not be understood as mandatory, and it should be understood that the described program components and systems can generally be integrated as a single software product or packaged as multiple software products.

Although the embodiments of the present disclosure have been described above with reference to the accompanying drawings, one of ordinary skill in the art should understand that the present disclosure may be embodied in other specific forms without changing the technical spirit or essential features. Therefore, the embodiments described above should be understood in all respects as illustrative and not limiting. The scope of protection of the present disclosure should be interpreted based on the following claims, and all technical ideas within the equivalent scope should be construed as included in the scope of rights of the present disclosure.

What is claimed is:

1. A route display method performed by a computing device, the route display method comprising:
displaying a driving guidance screen corresponding to a first junction included in an existing route from a departure point to a destination;
detecting flashing of a turn signal in a direction deviating from a direction corresponding to the existing route at a location corresponding to the first junction; and
in response to detecting the flashing of the turn signal, displaying information regarding a change from the existing route.

2. The route display method of claim 1, wherein displaying the information regarding the change from the existing route includes displaying the information regarding the change from the existing route prior to execution of a route update procedure that is performed as a position of the computing device is changed due to a turn in a direction of the turn signal and subsequent driving.

3. The route display method of claim 1, wherein displaying the information regarding the change from the existing route includes:
calculating a distance between the first junction and a position of the computing device; and
displaying the information regarding the change from the existing route on the driving guidance screen based on determining that the calculated distance is greater than or equal to a predetermined threshold.

4. The route display method of claim 1, wherein displaying the information regarding the change from the existing route includes:
calculating a time for the computing device to reach the first junction; and
displaying the information regarding the change from the existing route on the driving guidance screen based on determining that the calculated time is greater than or equal to a predetermined threshold.

5. The route display method of claim 1, wherein displaying the information regarding the change from the existing route includes:
measuring a flashing duration of the turn signal; and
displaying the information regarding the change from the existing route on the driving guidance screen based on determining that the measured flashing duration is greater than or equal to a predetermined threshold.

6. The route display method of claim 1, wherein displaying the information regarding the change from the existing route includes:
measuring a flash count of the turn signal; and
displaying the information regarding the change from the existing route on the driving guidance screen based on determining that the measured flash count is greater than or equal to a predetermined threshold.

7. The route display method of claim 1, wherein displaying the information regarding the change from the existing route includes:
measuring a moving speed of the computing device; and
displaying the information regarding the change from the existing route on the driving guidance screen based on detecting a change in the moving speed, of the computing device, resulting from the change from the existing route.

8. The route display method of claim 1, further comprising:
in response to detecting the flashing of the turn signal, calculating a probability of the change from the existing route to an alternative route; and
based on determining that the calculated probability is greater than or equal to a predetermined threshold, displaying information regarding the alternative route.

9. A route display method performed by a computing device, the route display method comprising:
displaying a driving guidance screen corresponding to a first junction included in an existing route from a departure point to a destination, wherein the existing route includes a left turn or a right turn at the first junction;
detecting absence of flashing of a turn signal at a location corresponding to the first junction; and
in response to detecting the absence of the flashing of the turn signal, displaying information regarding a change from the existing route on the driving guidance screen.

10. The route display method of claim 9, wherein detecting the absence of the flashing of the turn signal includes detecting a turn signal absence situation when a flashing state of the turn signal is maintained only for a time less than or equal to a predetermined threshold.

11. The route display method of claim 9, wherein detecting the absence of the flashing of the turn signal includes detecting a turn signal absence situation based on determining that a flash count of the turn signal is less than or equal to a predetermined threshold.

12. The route display method of claim 9, wherein displaying the information regarding the change from the existing route comprises:
measuring a moving speed of the computing device;
determining a variation in the measured moving speed; and
displaying the information regarding the change from the existing route based on determining that the variation does not fall within a predefined range of variations associated with a left turn or a right turn.

13. A route display method performed by a computing device, the route display method comprising:
displaying a driving guidance screen corresponding to a first junction included in an existing route from a departure point to a destination;
detecting flashing of a turn signal for a lane change at a location corresponding to the first junction; and
displaying information regarding a change from the existing route, resulting from the lane change.
